(19) United States
(12) Patent Application Publication
(10) Pub. No.: US 2009/0229475 A1
(43) Pub. Date: Sep. 17, 2009

(54) Cooking appliance

(75) Inventors: Ingo Bally, Traunstein (DE); Kerstin Feldmann, Bretten (DE); Wolfgang Fuchs, Altenmarkt a.d. Alz (DE); Martin Keller, Traunreut (DE); Edmund Kuttalek, Grassau (DE); Maximilian Neuhauser, Chieming/Egerer (DE); Klemens Roch, Trostberg (DE); Wolfgang Schnell, Trostberg (DE); Günter Zschau, Traunwalchen (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgeraete GmbH, Muenchen (DE)

(21) Appl. No.: 11/990,528

(22) PCT Filed: Jul. 26, 2006
(86) PCT No.: PCT/EP2006/064659

§ 371 Date: Feb. 14, 2008

(30) Foreign Application Priority Data
Aug. 17, 2005 (DE) 10 2005 038 881.7

(51) Int. Cl. A47J 27/00; F24C 15/00

(52) U.S. Cl. 99/337; 126/273 R

(57) ABSTRACT

A cooking appliance comprising at least one muffle which delimits a cooking chamber and whose muffle aperture is surrounded by a muffle frame, a door for closing the muffle aperture, said door being movable by means of a driving device, and a control circuit for triggering the driving device. The door can be moved only when at least one clearing safety signal is provided.

The present invention relates to a cooking appliance, in particular a high-level cooking appliance, having at least one muffle which delimits a cooking compartment and has a muffle opening, a door for closing the muffle opening, said door being movable by means of a drive device, and a control circuit for controlling the drive device.

Prior art high-level cooking appliances are known in which a base door can be caused to move in the desired direction by actuation of a corresponding travel button.

DE 101 64 239 A1, for example, discloses a generic high-level cooking appliance in which a control device controls the travel movement of a base door.

A disadvantage is that a simple door travel movement control of this kind affords no protection whatever against a malfunction of the control device and, with the exception of the pinching instance, also provides no further protective measures for the operator.

The object of the present invention is therefore to provide a cooking appliance, in particular a high-level cooking appliance, having improved operational safety during the travel movement of the base door.

The present object is achieved by means of the cooking appliance having the features recited in claim 1 and by means of a method as claimed in claim 18.

With that object in view, the cooking appliance, which is in particular a high-level cooking appliance but may also be a cooking appliance having a baking carriage, is designed in such a way that the door is only movable when at least one safety signal is present, which is to say a signal which activates specific functionalities by hardware or software means. Without the safety signal being present, no travel movement of the door is possible even when the travel switches are operated correctly. The safety signal is usually output by at least one processor unit, typically a microcontroller, in a defined manner, which is possible only if the device electronics or the electronics used for controlling the door's travel movement are in a proper condition. The safety signal can also be used to ensure compliance with further security conditions.

To provide an improved safeguard against unintentional travel movement, the door can beneficially be moved only if two safety signals are present together.

It is advantageous in particular if at least one of the safety signals is present or is generated only if a temperature of the closed cooking compartment is below a temperature threshold value, specifically if the temperature threshold value is 600° F. or 425° C. This can serve to prevent a user burning himself/herself on a part of the oven or on a dish that is too hot. It is equally advantageous if, in addition or alternatively, at least one of the safety signals is present only when a child safety device is not activated. By this means an unintentional travel movement triggered by children can be prevented.

It is also favorable if the safety signals are pulsed signals, in particular square wave signals, since in this way, when microcontrollers are used, their correct operation is ensured.

It is furthermore advantageous if a voltage supply for the drive device can additionally be switched on by means of one of the safety signals, since this results in a dual safety function (switching on/activation of the drive device).

It is advantageous for a safe, reliable and flexible design if the control circuit includes at least one lift board for actuating the drive device and a regulator board for controlling, switching and/or regulating the lift board.

Advantageously, a first, internal safety signal is generated by the lift board and a second, external safety signal is generated by the regulator board. The internal safety signal is preferably generated by the lift board in response to a travel movement signal S3, e.g. an actuation of a travel switch panel 25, 26 or a travel command of an automatic program. The external safety signal is favorably generated by the regulator board only at the request of the lift board. The regulator board is preferably connected to a temperature sensor for monitoring a temperature of the cooking compartment and/or to a child safety device in order thereby to control the corresponding activation/deactivation capability of the external safety signal. For this purpose a hardware-implemented circuit for deactivating the external safety signal is favorably present which is switchable in particular by means of signals from the temperature sensor and/or the child safety device, e.g. by means of a safety relay. However, the activation/deactivation capability can also be ensured by means of a computer program product for deactivating the external safety signal, which computer program product can likewise be controlled in particular by means of signals from the temperature sensor and/or the child safety device.

It is also advantageous if the drive device includes a drive motor which can be activated by means of directional relays which in turn are switchable in each case by means of at least one transistor, since transistors are particularly easy, quick and cheap to switch by means of control signals.

A typical application scenario comprises the following steps:
(a) generating a travel movement starting signal, in particular by actuating at least one travel switch panel;
(b) receiving the travel movement starting signal at the lift board;
(c) generating an internal safety signal on the lift board;
(d) requesting an external safety signal from the regulator board by the lift board;
(e) generating an external safety signal on the regulator board if no lock is present;
(f) if no lock is present, outputting the external safety signal to the lift board and to a voltage supply for the drive device;
(g) operating the drive device in the desired direction by means of the lift board, provided both the internal safety signal and the external safety signal are present.

To simplify operator control, the drive device can advantageously be operated by actuating both travel switch panels even if the main switch is switched off.

The invention is described in greater detail below with reference to the attached schematic figures, in which:

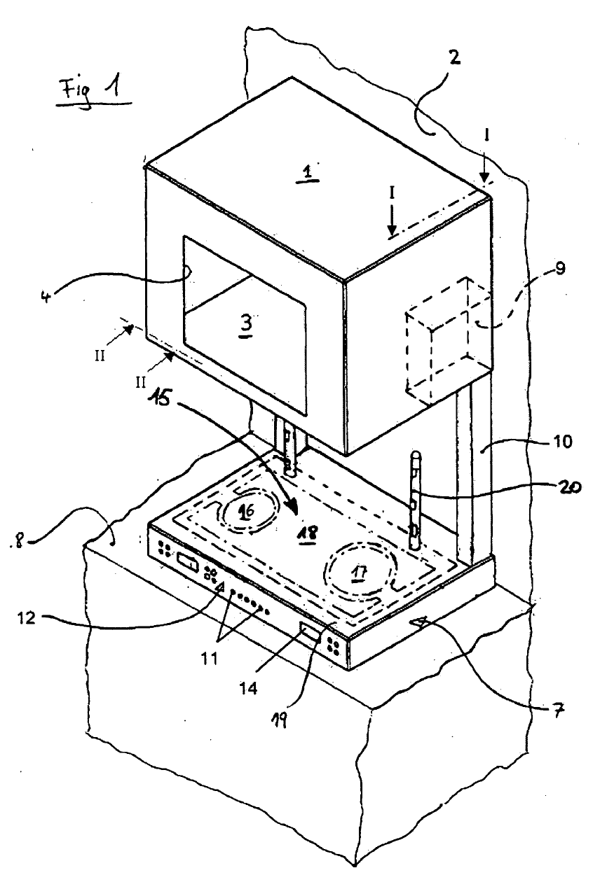

FIG. 1 shows a perspective view of a high-level cooking appliance which is mounted on a wall and has a lowered base door;

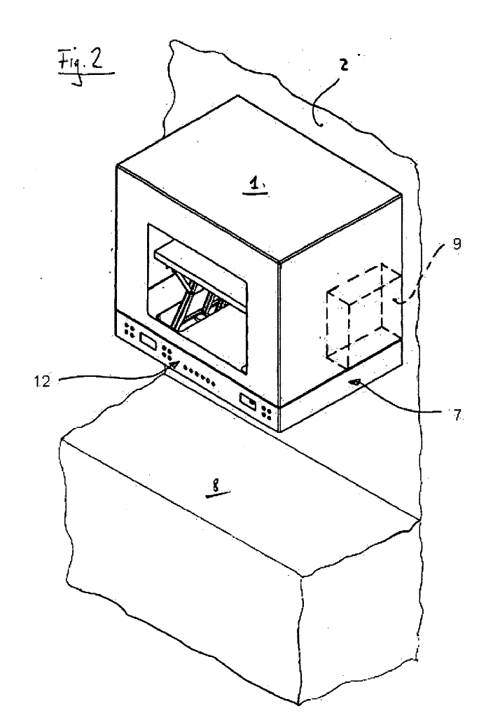

FIG. 2 shows a perspective view of the high-level cooking appliance with closed base door;

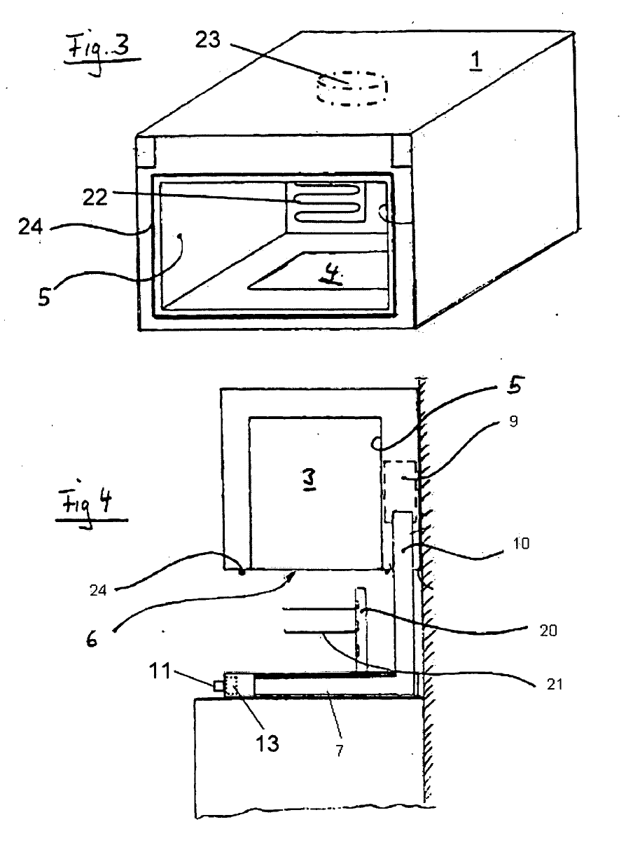

FIG. 3 shows a perspective view of a housing of the high-level cooking appliance without the base door;

FIG. 4 shows a schematic side view, in cross section along the line I-I from FIG. 1, of the high-level cooking appliance which is mounted on the wall and has a lowered base door;

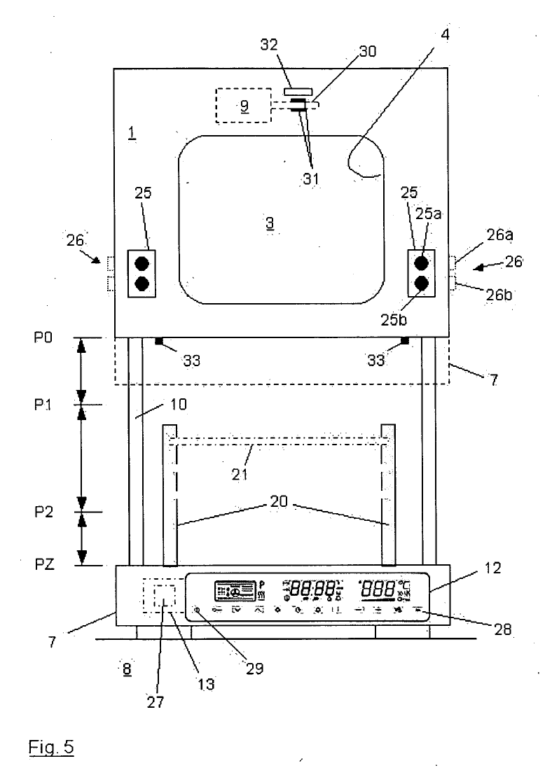

FIG. 5 shows a front view of a further embodiment of a high-level cooking appliance;

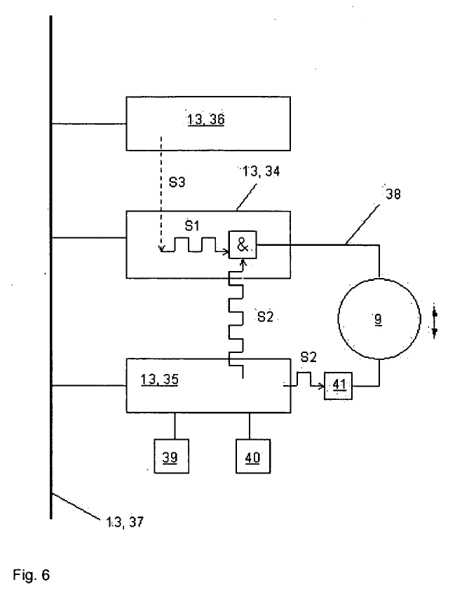

FIG. 6 is a schematic showing a layout of a control circuit in relation to a travel movement of the base door.

FIG. 1 shows a high-level cooking appliance with a housing 1. The rear side of the housing 1 is mounted on a wall 2 in the manner of a suspended cabinet. A cooking compartment 3, which can be monitored via a viewing window 4 installed in the front side of the housing 1, is defined in the housing 1. It can be seen from FIG. 4 that the cooking compartment 3 is delimited by a muffle 5 which is equipped with a heat-insulating jacket (not shown) and that the muffle 5 has a base-side muffle opening 6. The muffle opening 6 can be closed by means of a base door 7. The base door 7 is shown lowered in FIG. 1, wherein its underside is in contact with a work surface 8 of a kitchen entity. In order to close the cooking compartment 3, the base door 7 must be repositioned to the position shown in FIG. 2, the so-called “zero position”. For the purpose of repositioning the base door 7, the high-level cooking appliance has a drive device 9, 10. The drive device 9, 10 has a drive motor 9 which is illustrated by means of broken lines in FIGS. 1, 2 and 4 and is arranged between the muffle 5 and an external wall of the housing 1. The drive motor 9 is arranged in the region of the rear side of the housing 1 and, as shown in FIG. 1 or 4, has an active connection to a pair of lifting elements 10 which are connected to the base door 7. In this case, as shown in the schematic side view in FIG. 4, each lifting element 10 is designed in the form of an L-shaped carrier whose vertical limb extends from the drive motor 9 in the housing. For the purpose of repositioning the base door 7, the drive motor 9 can be actuated with the aid of an operating panel 12, which is arranged on the front of the base door 7 in accordance with FIGS. 1 and 2, and a control circuit 13. As shown in FIG. 4, the control circuit 13 is located behind the operating panel 12 within the base door 7. The control circuit 13, which is composed of a plurality of spatially and functionally separate printed circuit boards that communicate via a communication bus, represents a central control unit for the appliance operation and controls and/or adjusts e.g. heating, travel of the base door 3, conversion of user inputs, lighting, pinching protection, timing of heating elements 16, 17, 18, 22 and much more.

It can be seen from FIG. 1 that a top side of the base door 7 has a cooking matrix 15. Almost the entire surface of the cooking matrix 15 is occupied by heating elements 16, 17, 18, these being indicated in FIG. 1 by dash-dotted lines. In FIG. 1, the heating elements 16, 17 are two separate cooking position heating elements of different sizes, while the heating element 18 is a surface heating element which is provided between the two cooking position heating elements 16, 17 and almost surrounds the cooking position heating elements 16, 17. The cooking position heating elements 16, 17 define associated cooking zones or cooking rings for the user; the cooking position heating elements 16, 17 and the surface heating element 18 together define an underside-heating zone. The zones can be indicated by means of a suitable motif on the surface. The heating elements 16, 17, 18 can be controlled in each case via the control circuit 13.

In the exemplary embodiment shown, the heating elements 16, 17, 18 are embodied as radiant heating elements which are covered by a glass ceramic plate 19. The glass ceramic plate 19 has approximately the dimensions of the top of the base door 7. The glass ceramic plate 19 is also equipped with mounting openings (not shown), through which sockets project for the purpose of holding support parts 20 for cooking item carriers 21, as is also shown in FIG. 4. Instead of a glass ceramic plate 19, it is also possible to use other—preferably quick-reacting—covers, e.g. thin sheet metal.

With the aid of an operating knob which is provided in the operating panel 12, the high-level cooking appliance can be switched to a cooking position operating mode or an underside-heating operating mode, wherein these are explained below.

In the cooking position operating mode, the cooking position heating elements 16, 17 can be controlled individually via the control circuit 13 by means of operating elements 11 which are provided in the operating panel 12, while the surface heating element 18 remains unused. The cooking position operating mode can be implemented when the base door 7 is lowered as shown in FIG. 1. However, it can also be operated in an energy-saving function when the cooking compartment 3 is closed and the base door 7 is raised.

In the underside-heating operating mode, the control device 13 controls not only the cooking position heating elements 16, 17 but also the surface heating element 18.

In order to achieve a maximally even browning impression of the cooking item during the underside-heating operation, it is critical that the cooking matrix 15 which provides the underside heating exhibits an even distribution of the heat power output over the surface of the cooking matrix 15, even though the heating elements 16, 17, 18 have different nominal powers. Therefore the heating elements 16, 17, 18 are preferably not switched to a continuous operation by the control circuit 13, but the current supply to the heating elements 16, 17, 18 is timed. In this case, the different nominal heating powers of the heating elements 16, 17, 18 are reduced individually in such a way that the heating elements 16, 17, 18 provide an equal distribution of the heating power output over the surface of the cooking matrix 15.

FIG. 4 schematically shows the position of a fan 23, e.g. for the generation of recirculating air in the case of hot air operation or for supplying fresh air. Furthermore, provision is made for a topside-heating element 22 which is attached at a top side of the muffle 5 and can be embodied as a single circuit or multiple circuit, e.g. having an inner circuit and an outer circuit. It is also possible—not shown here for the sake of greater clarity—to provide for further heating elements such as a ring heating element between a rear wall of the housing 1 and the muffle. The different operating modes including e.g. topside-heating operation, hot-air operation or rapid-heating operation can be set by the control circuit 13 by switching on and setting the heating power of the heating elements 16, 17, 18, 22 correspondingly, optionally with activation of the fan 23. The setting of the heating power can be done by means of suitable timing. In addition, the cooking matrix 15 can be embodied differently, e.g. with or without a grilling zone, as a simple heat-retention zone (featuring a single circuit or multiple circuits) without cooking rings, etc. The housing 1 has a seal 24 which faces the base door 7. The operating panel 12 is normally arranged on the front side of the base door 7. Alternatively, other arrangements are also conceivable, e.g. on the front side of the housing 1, divided over various partial panels and/or partly on side surfaces of the cooking appliance. Further configurations are possible. The operating elements 11 are not restricted in terms of their construction, and can comprise e.g. operating knobs, tumbler switches, pushbuttons and plastic membrane buttons. The display elements 14 comprise e.g. LED, LCD and/or touchscreen displays.

FIG. 5 schematically shows a high-level cooking appliance from the front (not to scale), wherein the base door 7 is open and is in contact with the work surface 8. The closed state is drawn by means of a broken line.

In this embodiment there are two travel switch panels 25 on the front side of the permanently attached housing 1. Each travel switch panel 25 comprises two pushbuttons, specifically an upper CLOSE pushbutton 25a which causes a base door 7 to travel upward in a closing direction, and a lower OPEN pushbutton 25b which causes a base door 7 to travel downward in an opening direction. Without automatic operation (see below) the base door 7 only travels upward as a result of continuous simultaneous depression of the CLOSE buttons 25a of both travel switch panels 25, if possible; the base door 7 also only travels downward as a result of continuous simultaneous depression of the OPEN buttons 25b of both travel switch panels 25, if possible (manual operation). Since increased operating alertness on the part of the user is assumed in the case of manual operation, and both hands are also used here, pinching protection is only optional. In the case of an alternative embodiment, travel switch panels 26 are attached on opposite external sides of the housing 1 and have corresponding CLOSE buttons 26a and OPEN buttons 26b, as drawn using dotted lines.

The control circuit 13, which is drawn using dash-dotted lines and is located in the interior of the base door 7 behind the operating panel 12, switches the drive motor 9 in such a way that the base door 7 begins to move gently, i.e. not abruptly by simply starting the drive motor 9, but by means of a defined ramp.

In this exemplary embodiment, the control circuit 13 comprises a memory unit 27 for storing at least a destination or travel position P0, P1, P2, PZ of the base door 7, preferably using volatile memory modules, e.g. DRAMs. If a destination position P0, P1, P2, PZ is stored, following actuation of one of the buttons 25a, 25b or 26a, 26b of the travel switch panels 25 or 26, the base door can travel independently in the selected direction until the next destination position has been reached or until one of the buttons 25a, 25b or 26a, 26b is actuated again (automatic operation). In this exemplary embodiment, the lowermost destination position PZ corresponds to the maximum opening, the (zero) position P0 corresponds to the closed state, and P1 and P2 are freely selectable intermediate positions. If the last destination position for a direction has been reached, manual operation is additionally necessary for further travel, if possible (i.e. if the last final positions do not correspond to a maximally open final state or to the closed final state). Similarly, if no destination position is stored for a direction (which would be the case e.g. for an upward movement into the closed position if only PZ is stored but not P0, P1, P2), movement in this direction requires manual operation. If no destination position is stored, e.g. in the case of a new installation or following a power disconnection, no automatic operation is possible. If the base door 7 is to travel using the automatic operation, pinching protection is preferably activated.

Automatic operation and manual operation are not mutually exclusive: as a result of continuous actuation of the travel switch panel(s) 25, 26, the base door 7 also moves in manual operation if a destination position is nonetheless available in this direction. In this case, it is possible to define e.g. a maximum actuation time of the travel panels 25 or 26, or of the associated buttons 25a, 25b and 26a, 26b respectively, for the purpose of activating the automatic operation, e.g. 0.4 seconds.

A destination position P0, P1, P2, PZ can be any desired position of the base door 7 between and including the zero position P0 and the maximum opening position PZ. However, the maximum stored opening position PZ does not have to be the position which is in contact with the work surface 8. Storage of the destination position P0, P1, P2, PZ can be carried out with the base door 7 at the desired destination position P0, P1, P2, PZ by means of e.g. actuating a confirmation button 28 in the operating panel 12 for several seconds (e.g. two seconds). For the sake of greater clarity, available optical and/or acoustic signal emitters which output corresponding signals following storage of a destination position are not drawn. Arriving at the desired destination position P0, P1, P2, PZ to be set is achieved e.g. by means of—in this exemplary embodiment—two-handed operation of the travel switch panels 25 or 26 and manual travel to this position.

It is possible to store just one or, as shown in this exemplary embodiment, also a plurality of destination positions P0, P1, P2, PZ in the memory unit 27. In the case of a plurality of destination positions P0, P1, P2, PZ, these can be reached successively by actuating the corresponding travel buttons 25a, 25b or 26a, 26b. By virtue of a plurality of destination positions P0, P1, P2, PZ, the high-level cooking appliance can easily be adjusted to the desired operating height of a plurality of users. The destination position(s) can advantageously be deleted and/or overwritten. In one embodiment, for example, only one destination position in the open state can be stored, while the zero position P0 is detected automatically and can be reached automatically. Alternatively, the zero position P0 must also be stored in order that it can be reached automatically.

For ergonomic use it is particularly advantageous if the or a destination position P1, P2, PZ opens the base door 7 at least approximately 400 mm to approximately 540 mm (i.e. P1-P0, P2-P0, PZ-P0≧40 cm to 54 cm). At this opening distance, the cooking item carriers 21 can easily be inserted into the support parts 20. In this case, it is advantageous if the viewing window 4 is mounted at approximately eye level of the user or somewhat lower, e.g. by means of a template which indicates the dimensions of the cooking appliance.

A power failure protection for bridging power outages lasting approximately 1 to 3 s, preferably up to 1.5 s, is present but not illustrated.

The drive motor 9 from FIG. 1 has at least one sensor unit 31, 32 on a motor shaft 30, these being arranged before or after a transmission if applicable, in order to measure a travel displacement or a position and/or a speed of the base door 7. The sensor unit can comprise e.g. one or more induction sensors, Hall-effect sensors, optoelectronic sensors, SAW sensors, etc. In this case, in order to measure displacement and speed in a simple manner, two Hall-effect (partial) elements 31 are attached to the motor shaft 30 such that they are offset by 180°—i.e. opposite each other—and a Hall-effect measurement pick-up 32 is separately attached in a fixed manner in this region of the motor shaft. When a Hall-effect element 31 then travels past the measurement pick-up 32 as the motor shaft 30 rotates, a measurement signal or sensor signal is generated which is closely approximate to digital. Using (not necessarily) two Hall-effect elements 31, therefore, two signals are output with one rotation of the motor shaft 30. By analyzing these signals relative to time, e.g. their time difference, it is possible to determine the speed vL of the base door 7, e.g. using comparison tables or a real-time conversion in the control circuit 13. By means of adding or subtracting the measurement signals, it is possible to determine a travel displacement or a position of the base door 7.

A speed regulator can realize the speed e.g. via a PWM-controlled power semiconductor.

In order to determine the zero point, the displacement measurement is automatically reset by initializing in the zero position P0 of the base door 7 at each start-up, in order that e.g. an erroneous sensor signal output or sensor signal pick-up is not perpetuated.

The drive motor 9 can be operated by actuating both travel switch panels 25 or 26 even if the main switch 29 is switched off.

Instead of two separate switches per travel panel 25, 26, a single switch per travel panel is also possible, e.g. a tumbler switch which has a neutral position and only switches under pressure. Other forms are also possible. The type and arrangement of the operating elements 28, 29 of the operating panel 12 are likewise not restricted.

The arrangement and distribution of the control circuit 13 is flexible and not restricted in this case, and can therefore comprise a plurality of boards, e.g. a display board, a control board and a lift board, which are physically separate.

A 4-mm opening can be detected by stop switches 33 which, when actuated, deactivate a pinching protection.

The high-level cooking appliance can also be embodied without a memory unit 27, in which case no automatic operation is then possible. This can be suitable for increased operating safety, e.g. as protection against pinching.

FIG. 6 shows a schematic circuit diagram of the control circuit 13 connected to the drive motor 9. The control circuit 13 consists in this case of three separate boards or modules, specifically a lift board 34 for directly actuating the drive motor 9, a regulator board 35 for, inter alia, switching and/or regulating the lift board 34, and a display board 36 for controlling the operating panel 12, e.g. the display unit 14, and processing and/or forwarding actuation signals of the operating elements 11. The boards 34-36 are connected to one another for communication purposes via a DII bus line 37; the boards 34-36 can therefore also be arranged at different positions in the cooking appliance, e.g. the display board 36 behind the operating panel 12, the regulator board 35 in the stationary part of the housing 1, and the lift board 34 in proximity to the drive motor 9.

The direction of the travel movement of the drive motor 9 and consequently of the base door 3 is determined by two relays (not shown in the figure) which are controlled by means of transistors. If one of the relays is active, the drive motor 9 travels in the assigned direction. If both relays are active—something which should be prevented under normal conditions—the drive motor 9 blocks. If no relay is active, the motor 9 is short-circuited and no travel movement is possible (idle state). In this exemplary embodiment the motor 9 can only be driven if at least two safety signals are present; which is to say in this case that only then can the transistors be triggered accordingly. A first safety signal is a(n) (internal) safety signal S1 which is generated by the lift board 34 itself and is generated e.g. upon correct actuation of the travel movement or lift function, for example by actuation of the travel switches 25a, 25b, 26a, 26b. The first safety signal S1 ensures that a travel movement signal is correctly received and processed on the lift board 34—i.e. that no error-induced switching of the relays by the lift board 34 is present—as otherwise the circuit for the safety signal, typically a microcontroller, would not trigger. Accordingly, this safety signal S1 includes that the lift board electronics are basically operating correctly. The second safety signal is a(n) (external) safety signal S2 which is generated by the regulator board 35 and typically takes into account further states managed by the regulator board 35, e.g. a temperature in the closed cooking compartment 3 or an activation of a child safety device 40. In this embodiment the external safety signal S2 produces a dual activation: firstly the voltage supply for the relays and secondly, in conjunction with the internal safety signal S1, the corresponding transistor. In this exemplary embodiment the safety signals S1, S2 are pulse signals (“wiggler signals”), more precisely: square wave signals, clocked at 1 KHz, which is advantageous, since most available microcontrollers must operate correctly for this.

A typical sequence of an actuation of the drive motor 9 takes place as follows: a user wishes to open a closed cooking compartment 3 containing a prepared dish in order to remove said dish. For that purpose he/she briefly, i.e. for less than 0.4 seconds, presses one of the “OPEN” buttons 25b in the automatic mode of operation. The actuation of the “OPEN” button 25b is sensed by the display board 36 and in this exemplary embodiment is forwarded via the signal bus 37 to the lift board; alternatively the actuation signal S3 can be routed via a direct line to the lift board 34. The lift board 34 detects the correct actuation signal S3 and generates the internal safety signal S1. In addition, the lift board 34 now requests the external safety signal S2 from the regulator board 35 via the bus 37. The regulator board 35 checks whether any further conditions oppose a transmission of the external safety signal S2; thus, a check is made to verify firstly whether the child safety device 40 is switched off and secondly whether a temperature sensor 39 indicates a temperature in the cooking compartment 3 that is lower than a temperature threshold value of e.g. 425° C. or 600° F. The external safety signal S2 is output only if there are no further opposing conditions. In this embodiment the corresponding transistor and hence the corresponding directional relay are only triggered via a control line 38 if both the internal safety signal S1 and the external safety signal S2 are present. By means of the external safety signal S2 the voltage supply for the relays is activated in addition by switching-on of the transformer 41 for the drive motor 9. Only then can the drive motor 9 be actuated, and the base door 3 executes a travel movement accordingly. The external safety signal S2 thus has a dual safety function. Alternatively, however, the external safety signal S2 may also have only one of these functionalities. Furthermore, before the travel movement of base door 7 is initiated, both relays are additionally checked to verify their functionality.

The regulator board 35 uses a temperature measurement output by the temperature sensor 39, e.g. a Pt500 or Pt1000 temperature sensor, to check, for example, whether the cooking compartment 3 is too hot to be opened. If the temperature is above a certain temperature threshold value, e.g. 415° C. or 600° F., the regulator board 35 does not output an external safety signal and the travel movement of the base door 7 is not triggered (locking). This locking or, as the case may be, deactivation of the external safety square wave signal S2 can be effected by way of a hardware circuit, e.g. in such a way that if the temperature threshold value is exceeded, a switch required for switching the external safety signal S2 is forced to open or remains open. Alternatively the lock can also be applied under program control.

The control circuit 13 may also be subdivided differently or not be subdivided at all. Obviously, the type and arrangement of the circuitry and signal controller are also not limited to the exemplary embodiment described. Furthermore, more or fewer than two safety signals may be used, e.g. only safety signal S1 or S2, since even just one safety signal provides increased functional safety when travel movements are executed. It is also possible that further safety conditions are to be complied with during travel movements of the door.

### LIST OF REFERENCE SIGNS

1 Housing
2 Wall
3 Cooking compartment
4 Viewing window
5 Muffle
6 Muffle opening
7 Base door
8 Work surface
9 Drive motor
10 Lifting element
11 Operating element
12 Operating panel
13 Control circuit
14 Display elements
15 Cooking matrix
16 Cooking position heating element
17 Cooking position heating element
18 Surface heating element
19 Glass ceramic plate
20 Support part
21 Cooking item carrier
22 Top heating element
23 Fan
24 Seal
25 Travel switch panel
25a Travel switch upward
25b Travel switch downward
26 Travel switch panel
26a Travel switch upward
26b Travel switch downward
27 Memory unit
28 Confirmation button
29 Main switch
30 Motor shaft
31 Hall-effect element
32 Measurement pick-up
33 Stop switch
34 Lift board
35 Regulator board
36 Display board
37 Bus line
38 Control line
39 Temperature sensor
40 Child safety device
41 Transformer
FT1 First force/time profile
FT2 Second force/time profile
P0 Zero position
P1 Intermediate position
P2 Intermediate position
PZ Final position
R1 Speed ramp
R2 Speed ramp
S1 Internal safety signal
S2 External safety signal
S3 Travel movement signal
vL Travel speed of the base door

1-19. (canceled)

20. A cooking appliance comprising:
a muffle which defines a cooking compartment and includes a muffle opening,
a door for closing the muffle opening,
a drive device for moving the door between an opened condition and a closed condition with respect to the muffle opening, and
a control circuit for controlling the drive device wherein the door cannot be activated for movement unless at least one safety signal is received by the control circuit.

21. The cooking appliance according to claim 20 wherein the control circuit is configured to activate driven door movement when two safety signals are received by the control circuit.

22. The cooking appliance according to claim 20 wherein at least one of the safety signals is generated responsive to a temperature within a closed cooking compartment being below a predetermined temperature threshold value.

23. The cooking appliance according to claim 22 wherein at least one of the safety signals is generated responsive to a temperature within a closed cooking compartment being below 600° F. (425° C.).

24. The cooking appliance according to claim 20 wherein the at least one safety signal is generated only if a child safety device in electrical communication with the control circuit is not activated.

25. The cooking appliance according to claim 20 wherein the at least one safety signal is formed as a pulsed square wave signal.

26. The cooking appliance according to claim 20 wherein the control circuit is configured to activate a voltage supply for a drive motor of the drive device responsive to at least one safety signal.

27. The cooking appliance according to claim 20 wherein the control circuit includes at least one lift board configured to activate a voltage supply for a drive motor of the drive device and a regulator board for at least one of switching and regulating the lift board.

28. The cooking appliance according to claim 27 wherein an internal safety signal is generated by the lift board and an external safety signal is generated by the regulator board.

29. The cooking appliance according to claim 27 wherein the internal safety signal can be generated by the lift board in response to a travel movement signal.

30. The cooking appliance according to claim 28 wherein the external safety signal can be generated by the regulator board as directed by the lift board.

31. The cooking appliance according to claim 28 wherein the regulator board is in operational communication with one of a temperature sensor for monitoring a temperature of the cooking compartment and a child safety device.

32. The cooking appliance according to claim 31 and further comprising a circuit for deactivating the external safety signal, with the deactivation circuit being switchable responsive to signals from one of the temperature sensor and the child safety device.

33. The cooking appliance according to claim 31 and further comprising a computer program product for deactivating the external safety signal responsive to signals from one of the temperature sensor and the child safety device.

34. The cooking appliance according claim 20 wherein the drive device includes a drive motor in operational communication with a plurality of directional relays for selective actuation thereby with the directional relays being switchable by at least one transistor operatively associated therewith.

35. The cooking appliance according to claim 27 and further comprising at least one bus line in communication with the lift board and the regulator board for communication between the lift board and the regulator board.

36. The cooking appliance according to claim 20 wherein said cooking appliance is configured for mounting above countertop level with a plurality of sides and a downwardly directed muffle opening and the door is configured for covering the downwardly directed muffle opening.

37. A method for operating cooking appliance comprising the following steps:
(a) generating a travel movement starting signal, in particular by actuating at least one travel switch panel;
(b) receiving the travel movement starting signal at the lift board;
(c) generating an internal safety signal on the lift board;
(d) requesting an external safety signal from the regulator board by the lift board;
(e) generating an external safety signal on the regulator board if no lock is present;
(f) determining whether a lock is present and when no lock is present, outputting the external safety signal to the lift board and to a voltage supply for the drive device;
(g) operating the drive device in the desired direction by means of the lift board, provided both the internal safety signal and the external safety signal are present.

38. A method for operating a cooking appliance comprising the steps of:
providing a muffle which defines a cooking compartment and includes a muffle opening, a door for closing the muffle opening, a drive device for moving the door between an opened condition and a closed condition with respect to the muffle opening, and a control circuit for controlling the drive device; and
controlling the drive device with the control circuit for initiating movement of the door when at least one safety signal received by the control circuit.
